(19) United States
(12) Patent Application Publication
(10) Pub. No.: US 2006/0036610 A1
(43) Pub. Date: Feb. 16, 2006

(54) File conversion and sharing system and the method of the same

(75) Inventor: Wen-Jiunn Wang, Xindian City (TW)

Correspondence Address: BRUCE H. TROXELL;SUITE 1404, 5205 LEESBURG PIKE, FALLS CHURCH, VA, 22041, US

(73) Assignee: Reallusion Inc.

(21) Appl. No.: 11/201,149

(22) Filed: Aug. 11, 2005

(30) Foreign Application Priority Data
Aug. 13, 2004 (TW) 93124284

(51) Int. Cl. G06F 17/30

(52) U.S. Cl. 707/10; 707/100; 707/104.1

(57) ABSTRACT

The present invention discloses file conversion and sharing system and the method of the same, specifically file conversion and sharing system and method that is able to convert different file formats and transfer the file to different terminal devices (such as a personal computer or a hand-held terminal device) via the Internet. The present invention mainly comprises a terminal device configuration database for storing a plurality of configuration information for different terminal devices, a data conversion module for converting data based on the configuration information in the terminal device configuration database and a storage unit for storing data. The network user can transfer data (or file) with a terminal device to the storage unit of the present invention via Internet, the data conversion module converts the data and stores the data in the storage unit to share the data, when another network user wants to view or download the data using a terminal device, the data conversion module may convert the data properly based on the configuration information of the terminal device stored in the terminal device configuration database, and the converted file may be properly transferred or display on the terminal device.

### 1. FIELD OF THE INVENTION

The present invention relates to file conversion and sharing system and the method of the same, and more particularly, to the system and method that provide file conversion and sharing service via the Internet based on different terminals devices.

### 2. BACKGROUND OF THE INVENTION

As the Internet has been widely spread, contents providers (CP) that provide various contents on the Internet have also increased, Particularly, since transmission speeds of the Internet have become faster, the categories of the contents provided by the contents providers have been expanded to various media such as still images, moving pictures and music, as well as text.

Also, as the use of hand-held wireless terminal devices such as mobile phone and wireless personal digital assistants (PDA) have been greatly popularized, e-mail service and Internet contents searching and sharing service via the hand-held wireless terminal devices are increasing.

Although the user of hand-held wireless terminal devices can use the multimedia data in various applications and services provided by the hand-held wireless terminal devices, many shortcomings still need to be improved.

First, the operational flows of every application or service in the hand-held wireless terminal devices are different, the user needs to learn many various different user interfaces to operate these devices.

Second, different applications and services lack one integrated user interface so that the user needs to switch in between to operate the device.

Third, every different hand-held wireless terminal device has its own applications and services, the user is not able to use all applications and services that he needs in one single device.

Therefore, to improve the disadvantages illustrated above, the present invention provides the file conversion and sharing system and method which link and integrate different applications and services together, regardless the applications or the services are on the local side of the hand-held wireless terminal device or on the remote side over the Internet. With the present invention, the user is able to operate the hand-held wireless terminal device and use the multimedia applications and services within a single integrated environment. Thereby, the convenience of the use of the hand-held wireless terminal device is improved, the user wouldn't need to know exactly whether the applications or the services are residing either on the local side or the remote side, but just use a single integrated environment to fully utilize the system.

Moreover, even the user of the hand-held wireless terminal device is able to process the data with the device, some problems still exist in practice.

First, the hand-held wireless terminal device is different from the regular personal computer (PC) in the aspects of display standards, memory capacity and CPU performance etc., sometimes data or contents designed for personal computer cannot be properly displayed or performed on the hand-held wireless terminal device.

Second, since the overall system configuration of the regular personal computer is superior to that of the hand-held wireless terminal device, the hand-held wireless terminal device needs much longer time to process same volume of information as does by the regular personal computer, especially in the case when the information contains large volume of graphic and text data.

Traditionally, the hand-held wireless terminal device is the secondary choice for a data processing device for its limited system performance, especially in some certain cases in which large volume of image data need to be processed.

Accordingly, the present invention provides the file conversion and sharing system and method, thereby the user of the hand-held wireless terminal device does not need to be familiar with many different user interfaces of various applications and service but just face a single integrated interface to employ the system so as to extend the computing power of the hand-held wireless terminal device, such as the memory capacity and the system performance of CPU.

The present invention also addresses some other problems that happen on the hand-held wireless terminal device, First, every hand-held wireless terminal device has its own system configuration which varies device by device. Therefore, playing same multimedia data on different hand-held wireless terminal device is not a simple work. Second, when one hand-held wireless terminal device needs to display multimedia data from other hand-held wireless terminal device, some complex operations and processes are required, but even though, the data may not be displayed properly.

Therefore, the present invention of file conversion and sharing system and method provides a solution with which, when multimedia data in a hand-held wireless terminal device is needed to be transferred to another hand-held wireless terminal device, the multimedia data is converted optimally first in aspects of the format, size, resolution of the data according to the configuration and capability information of said another hand-held wireless terminal device so that the data can be displayed on various hand-held wireless terminal device and the ease of downloading, exchanging, playing of such multimedia data is improved.

### SUMMARY OF THE INVENTION

The primary object of the invention is to provide file conversion and sharing system and the method which integrate different applications and services together to enable the user of the hand-held wireless terminal device to operate the hand-held wireless terminal device and use the multimedia applications and services within a single integrated environment without having to know exactly whether the applications or the services are residing either on the local side or the remote side, so that the convenience of the use of the hand-held wireless terminal device is improved.

It is another object of the invention to provide the file conversion and sharing system and method, thereby the user of the hand-held wireless terminal device does not need to be familiar with many different user interfaces of various applications and service but just face a single integrated interface to employ the system so as to extend the computing power of the hand-held wireless terminal device, such as the memory capacity and the system performance of CPU.

Yet, another object of the invention is to provide file conversion and sharing system and method with which the multimedia data can be converted optimally in aspects of the format, size, resolution of the data according to the configuration and capability information of different hand-held wireless terminal device so that the data can be displayed on various hand-held wireless terminal device and the ease of downloading, exchanging, playing of such multimedia data is improved.

### BRIEF DESCRIPTION OF THE DRAWINGS

FIG. 1 is a schematic diagram showing the system structure according to the present invention.

FIG. 2 is a schematic diagram showing the system structure according to one embodiment of the present invention.

FIG. 3 is a schematic diagram showing the operation flowchart according to the present invention.

### DESCRIPTION OF THE PREFERRED EMBODIMENT

In the following detailed description, only the preferred embodiments of the invention have been shown and described, simply by the way of illustration of the best modes contemplated by the inventor(s) of carrying out the invention. As will be realized, the invention is capable of modification in various obvious respects, all without departing from the invention. Accordingly, the drawings and description are to be regarded as illustrative in nature, and not restrictive.

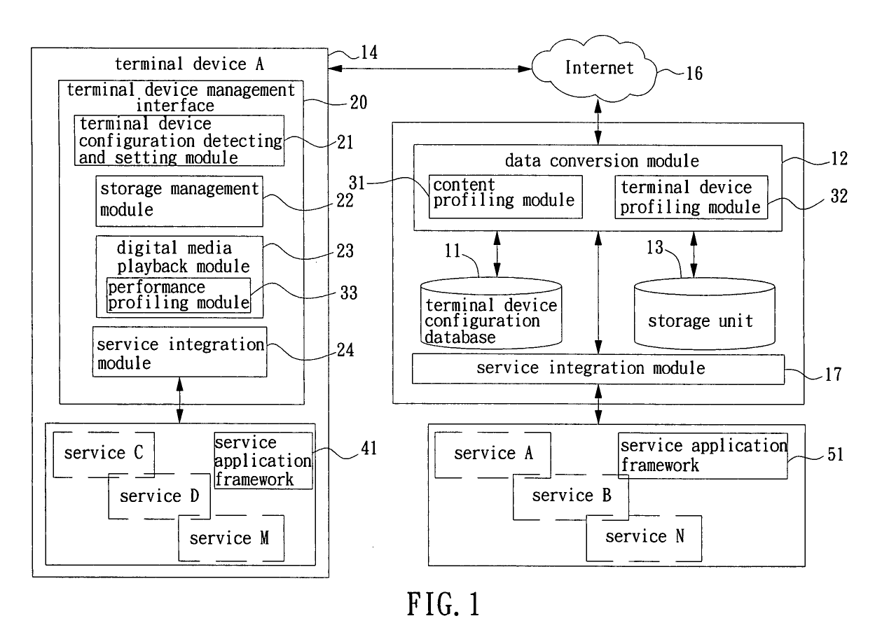

Please refer to FIG. 1 first, which is a schematic diagram showing the system structure according to the present invention. As shown, the file conversion and sharing system of the present invention comprises a terminal device configuration database 11 for storing a plurality of configuration information of various terminal devices; a data conversion module 12 for converting data according to the configuration information of a terminal device stored in the terminal device configuration database 11, the data conversion module 12 further comprises a content profiling module 31 for parsing multimedia data for transferring to allocate the optimal conversion parameter and a terminal device profiling module 32 for parsing the configuration of a terminal device when the device is requesting for transferring the multimedia data, and for allocating the best optimal conversion parameter by referring the best optimal conversion parameter output from the content profiling module 31; a storage unit 13 for storing data; a service integration module 17 for integrating a service application framework 51 and a plurality of services, the service application framework 51 defines the specification of the service and the mechanism of the integration, the value-added service (such as the service A, B and N in the figure) being developed based on the service application framework 51 is capable of integrating with the service integration module 17; a Internet 16 for providing the network linage and the transferring data and a terminal device 14 for processing data, the terminal device 14 further comprises a terminal device management interface 20 for integrating and managing various multimedia applications and services in the terminal device so that the user of the device is able to operate the device in a single integrated environment without having to know exactly the locations of the multimedia applications and the services and to use the multimedia applications and the service not on the local side of the terminal device, the terminal device management interface 20 further comprises a terminal device configuration detecting and setting module 21 for detecting and setting a terminal device in aspects of the resolution, color, speed of CPU, memory size and storage capacity of the terminal device; a storage management module 22 for managing either the storage of the terminal device or the storage locating on a server side (e.g. a remote side over the network), the module 22 is also responsible for the management of the multimedia data (such as sharing viewing, downloading and uploading) and therefore automatically extending the storage capacity of the terminal device so that the user can use extra storage capacity without having to know the exact location of the storage; a digital media playback module 23 for playing digital media optimally, the digital media playback module 23 further comprises a performance profiling module 33 for analyzing the efficiency of the terminal device to obtain the best playing mode of the terminal device when multimedia data is downloaded for playing on the device; and a service integration module 24 for integrating a service application framework 41 and a plurality of services in the terminal device 14, the service application framework 41 defines the specification of the service and the mechanism of the integration, the value-added service (such as the service C, D and M in the figure) being developed based on the service application framework 41 is capable of integrating with the service integration module 24, the service can be the common value-added service on the market such as the modification of a image file which can provide the service like white balancing, purifying, image synthesizing and image enhancement of a graph or a image in a film, the service also covers the manipulation of the text, image and film, which can produce a piece of film based on a scenario, or produce a piece of film or animation with speaking role based on a facial image, or convert a piece of text from 2D to 3D, still image, stream image, film or animation, the module also can provide audio service such as produce a piece of sound based on a scenario. In one embodiment according to the present invention, the user can use the terminal device 14 (such as a personal computer or a hand held wireless terminal device) to upload data to the data conversion module 12 via the Internet 16 to converting the data into different format, the converted data can be stored in the storage unit 13 of the present invention for other users' downloading and viewing.

Moreover, the value-added service mentioned above can reside on a server side (the same side the above-identified terminal device configuration database, data conversion module, and storage unit are residing), the user can utilize the service integration module (on the terminal device side) to list and view all the value-added services on the terminal device side so that the user can pick up certain value-added services for use. Every value-added service includes the definition of multimedia data format for input and output. With the storage management module of the present invention, the user is able to select and set up some certain multimedia file for input or output and the multimedia file can be either on the terminal device side or on the server side and the value-added service that the user can select also can be either on the terminal device side or on the server side as well.

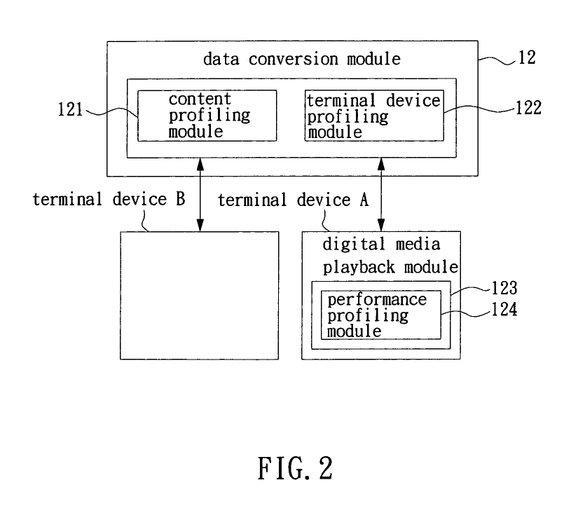

Next, please refer to FIG. 2. FIG. 2 is a schematic diagram showing the system structure according to one embodiment of the present invention. As shown, the data conversion module 12 of the present invention further comprises a content profiling module 121 and terminal device profiling module 122, which can parse multimedia data for transferring to allocate the best optimal conversion parameter and parse the configuration of a terminal device when the device is requesting transferring the multimedia data respectively, the combination of the parsing result of these two modules will be used to configure the terminal device for optimal viewing and playing. The two modules are illustrated in more details as the following.

The content profiling module is used to parse multimedia data for transferring to allocate the best optimal conversion parameter. For example, the result of analyzing one stream image of enlarging a close-up facial image is totally different from that of analyzing the vehicle flow at an intersection. Obviously, the stream of enlarging a close-up facial image is more static than that of the vehicle flow at an intersection which also has more complex file transferring issue needed to be put into consideration, therefore more system resource will be allocated for use, the conversion parameters for both situations are different in many ways.

The terminal device profiling module is used to analyze the configuration of a terminal device when the device is requesting for transferring multimedia data, and further refer the optimal conversion parameter output from the content profiling module to allocate the optimal conversion parameter so that the multimedia data being downloaded can be viewed or played optimally.

In addition, as shown in FIG. 2, the digital media playing module 24 of the terminal device further comprises a performance profiling module 124 for analyzing the efficiency of the terminal device to obtain the optimal playing mode for the terminal device to play multimedia data when the multimedia data is downloaded to the device. For example, when the available playing speed of the terminal device is 6 FPS, but the multimedia data is for 10 FPS, the module will allocate the optimal mode of 6 FPS for the terminal device to play the multimedia data.

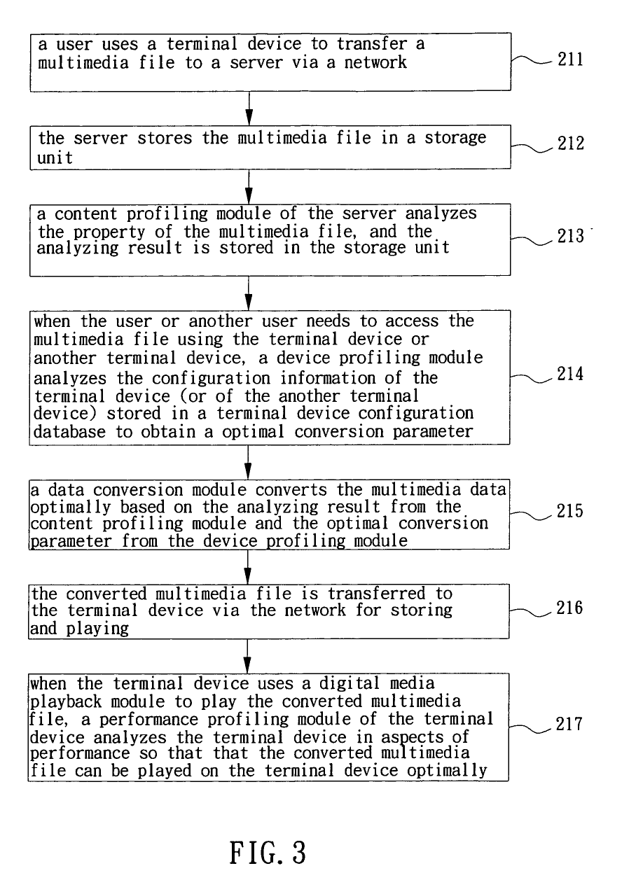

Please refer to FIG. 3. FIG. 3 is a schematic diagram showing the operation flowchart according to the present invention. As shown in FIG. 3, the file conversion and sharing method of the present invention at least comprises the following steps:

Step 211: a user uses a terminal device to transfer a multimedia file to a server via a network;

Step 212: the server stores the multimedia file in a storage unit;

Step 213: a content profiling module of the server analyzes the property of the multimedia file, and the analyzing result is stored in the storage unit;

Step 214: when the user or another user needs to access the multimedia file using the terminal device or another terminal device, a device profiling module analyzes the configuration information of the terminal device (or of the another terminal device) stored in a terminal device configuration database to obtain a optimal conversion parameter;

Step 215: a data conversion module converts the multimedia data optimally based on the analyzing result from the content profiling module and the optimal conversion parameter from the device profiling module;

Step 216: the converted multimedia file is transferred to the terminal device via the network for storing and playing;

Step 217: when the terminal device uses a digital media playback module to play the converted multimedia file, a performance profiling module of the terminal device analyzes the terminal device in aspects of performance so that that the converted multimedia file can be played on the terminal device optimally.

In order to describe the sprit of the invention, the aforementioned steps can be illustrated in more details as follows.

When a network user needs to transfer or share data (file) with other network users, he can use a terminal device (a regular personal computer or a hand-held wireless terminal device) to transfer the data (file) to a storage unit of the present invention via a network (such as the Internet), when another user wants to view or download the data, he can use a terminal device to do so, however, every terminal device has its own configuration in terms of storing capacity, display standard and memory size. In many circumstances, the content of the data may not display properly on the screen of the terminal device, moreover, the format of data also affect the quality of data receiving and displaying. For example, the size of .jpg file is much smaller than that of .bmp file, so, transferring or receiving a .bmp file needs much longer time. The data conversion module may convert the file properly based on the configuration information of the terminal device stored in a terminal device configuration database, and the converted file may be properly transferred or display on the terminal device.

In more details, the data conversion module of the present invention may convert a file based on the hardware configuration information of the terminal device stored in the terminal device configuration database. For example, the file can be converted in many aspects, such as reducing the size of the file and the number of color, to meet the requirement of the hardware configuration of the terminal device. In another preferred embodiment, the size of the hand-held wireless terminal device is much different form that of a PDA (Personal Digital Assistant) or a mobile phone, the data conversion module of the present invention may convert the file based on the display size information stored in the terminal device configuration database, so that the file can be displayed properly on the screen of the PDA or mobile phone.

The data conversion module of the present invention is not just capable of converting the file based on the configuration of the terminal device, but also capable of compressing the file based on the information of the file format, the storing capacity of the terminal device and the optimal file transferring method to increase the speed of file transferring.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention. For example, the terminal device mentioned in this specification may be a personal computer (PC), a personal digital assistant (PDA), a mobile phone or other types of device. Besides the Internet, the content provider can provide service in different types of network. As mentioned previously, the data is converted properly before transferring, so the user of the terminal device is able to download and display the data optimally. In addition, the data is compressed properly, so it can be transferred efficiently in a relative lower speed environment.

What is claimed is:

1. A file conversion and sharing system, which comprising at least:
a terminal device configuration database for storing a plurality of configuration information of various terminal devices;
a data conversion module for converting data based on the configuration information of a terminal device stored in the terminal device configuration database;
a storage unit for storing user data;
a service integration module with a service application framework for integrating the system with a plurality of services;
a network for providing network linkage and transferring service; and
a terminal device for processing data;
wherein a user can use the terminal device to store data in the storage unit via the network, when other terminal device needs to download or view the data via the network, the data conversion module converts the data based on the configuration information of the other terminal device, then the converted data is transferred or displayed to the other terminal device via the network.

2. The file conversion and sharing system of claim 1, wherein the data conversion module further comprises a content profiling module for analyzing multimedia data for transferring to setup optimal conversion parameters.

3. The file conversion and sharing system of claim 1, wherein the data conversion module further comprises a terminal device profiling module for analyzing the configuration of the destination terminal device to further optimize the conversion parameters provided by the content profiling module.

4. The file conversion and sharing system of claim 1, wherein the terminal device further comprises a terminal device management interface, which comprising:
a terminal device configuration detecting and setting module for detecting and setting the configuration information of the terminal device;
a storage management module for managing the storage units or the terminal device;
a digital media playback module for playing digital media with optimal quality and performance; and
a service integration module with a service application framework for integrating the system with a plurality of services;

5. The file conversion and sharing system of claim 1, wherein the configuration information of various terminal devices can be updated either manually or automatically.

6. The file conversion and sharing system of claim 1, wherein the terminal device can be one of the following devices or the combinations thereof: desktop computers, notebook computers, workstations, hand-held devices, 2.5G/3G mobile phones, Personal Digital Assistance (PDA) devices and any other device which is able to access network services.

7. The file conversion and sharing system of claim 1, wherein the application service can be a value-added service.

8. The file conversion and sharing system of claim 4, wherein the storage management module can manage and access the storage unit either on the local terminal device or a remote server.

9. The file conversion and sharing system of claim 4, wherein the storage management module is to manage the digital media.

10. The file conversion and sharing system of claim 4, wherein the digital media playback module is capable of playing back various digital files with the formats including text, image, music, video, and audio files and combinations.

11. The file conversion and sharing system of claim 4, wherein the application service can be a value-added service.

12. The file conversion and sharing system of claim 4, wherein the service application framework defines the specification of the application service and the mechanism for integration, a value-added service being developed based on the service application framework can be integrated into the system automatically by the service integration module.

13. A file conversion and sharing method, which comprising at least the following steps:
a) a user uses a terminal device to transfer a multimedia file to a server via a network;
b) the server stores the multimedia file in a storage unit;
c) a content profiling module sets up the optimal parameters according to the result of analyzing the characteristic of the multimedia file and store the parameters to the storage unit;
d) when the user or another user requests to access the multimedia file using the terminal device or another terminal device, a device profiling module analyzes the configuration information of the terminal device or of the another terminal device stored in a terminal device configuration database to obtain the optimal conversion parameters;
e) a data conversion module converts the multimedia data optimally based on the optimal combination of the content profiled and device profiled parameters;
f) the converted multimedia file is transferred to the terminal device via the network for the file storage and playback;
g) when a digital media playback module of the terminal device plays the converted multimedia file, a performance profiling module of the terminal device monitors the performance of the terminal device to adaptively play back the multimedia file according to a performance benchmark.

14. The file conversion and sharing method of claim 14, wherein the terminal device configuration database comprises a plurality of configuration information of various terminal devices, and to update the plural configuration information of various terminal devices can be either manually or automatically.

15. The file conversion and sharing method of claim 14, wherein the terminal device can be one of the following devices or the combinations thereof: desktop computers, notebook computers, workstations, hand-held devices, 2.5G/3G mobile phones, Personal Digital Assistance (PDA) devices and any other device which is capable of accessing network services.

16. The file conversion and sharing method of claim 14, wherein the multimedia file can be one of the following formats or their combinations: text, image, music, video and audio.
